(19) United States
(12) Patent Application Publication
(10) Pub. No.: US 2025/0389008 A1
(43) Pub. Date: Dec. 25, 2025

(54) NEW COMPOSITE LAYER AND METHOD OF PRODUCING A COMPOSITE LAYER

(71) Applicant: AETHERPHLOX AB, Åkersberga (SE)

(72) Inventors: Georgios Sotiriou, Åkersberga (SE); Staffan Normark, Stockholm (SE); Birgitta Henriques Normark, Stockholm (SE); Eleni Bletsa, Loannina (GR)

(21) Appl. No.: 18/877,729

(22) PCT Filed: Jun. 23, 2023
(86) PCT No.: PCT/EP2023/067182

§ 371 Date: Dec. 20, 2024

(30) Foreign Application Priority Data
Jun. 23, 2022 (SE) 2250791-7

(51) Int. Cl. C23C 4/129; C23C 4/11

(52) U.S. Cl. CPC C23C 4/129; C23C 4/11

(57) ABSTRACT

Described is a method that utilises a process of producing photocatalytic nanoparticles in situ by flame spray pyrolysis (FSP) and depositing the nanoparticles on the substrate via aerosol deposition to produce a photocatalytic nanoparticle film on the substrate, followed by immersing the photocatalytic nanoparticle film with a polymer solution, or a liquid polymer precursor material, to form a composite layer. The method used results in a composite layer that includes a percolating network of photocatalytic nanoparticles in a polymer matrix, wherein the composite layer has enhanced durability and maintains activity after several cycles of irradiation, which is an improvement over currently known coatings.

### FIELD OF THE INVENTION

The present invention relates to a new composite layer. In particular, the invention relates to new composite layers comprising a percolating network of photocatalytic nanoparticles in a polymer matrix. Furthermore, the invention relates to a method for producing the composite layer, uses of the composite layer and articles coated with the composite layer.

### BACKGROUND AND PRIOR ART

Biofilms are the colonies of bacteria that grow on the surface of medical devices, such as catheters, implants, and wound meshes, and correlate with nosocomial infections. Thus, biofilms pose a serious threat to public health and economy, causing worldwide morbidity. Biofilm bacteria are usually embedded into endogenously-produced extracellular polymeric substances (EPSs), which typically contain polysaccharides, proteins, nucleic acids, and lipids. The EPSs make the biofilms 10-1000 times more resistant against antibiotics compared to planktonic bacteria. Therefore, this high antimicrobial drug resistance of biofilms incites research for the development of novel antibiotic-free strategies.

There are several antibiotic-free strategies for the prevention and treatment of biofilms on medical devices and one path of investigation has been to use photocatalytic nanomaterials to attempt to overcome the antibiotic-resistance mechanisms of bacteria, for example by coating photocatalytic semiconducting nanoparticles on medical devices and destroying bacteria and the corresponding biofilms upon light irradiation through generated reactive oxygen species (ROS).

To enable photocatalytic nanoparticles to impart antimicrobial activity when coated on articles it is necessary for the generated ROS to be able to leave the surface of the coated article and reach the bacteria/microbe so that it may be destroyed. However, current coatings available suffer from certain drawbacks such as low mechanically stability and durability of the coatings, leading to the nanomaterial detaching from the surface over time, which can lead to toxicity issues in vivo and also to the coating no longer providing an anti-microbial effect.

Therefore, there is a need for coatings containing photocatalytic nanoparticles that exhibit anti-microbial activity through ROS generation on irradiation with the coating exhibiting enhanced durability and activity over several cycles to ensure continuous biofilm destruction.

### DESCRIPTION OF THE INVENTION

The inventors have surprisingly found a method that utilises a process of producing photocatalytic nanoparticles in situ by flame spray pyrolysis (FSP) and depositing the nanoparticles on the substrate via aerosol deposition to produce a photocatalytic nanoparticle film on the substrate, followed by immersing the photocatalytic nanoparticle film with a polymer solution, or a liquid polymer precursor material, to form a composite layer.

The process results in a composite layer comprising a percolating network of photocatalytic nanoparticles in a polymer matrix, wherein the composite layer has enhanced durability and maintains activity after several cycles of irradiation, which is an improvement over currently known coatings.

Unless otherwise indicated, all technical and scientific terms used herein have the same meaning as commonly understood by one of ordinary skill in the art to which this invention pertains.

All embodiments of the invention and particular features mentioned herein may be taken in isolation or in combination with any other embodiments and/or particular features mentioned herein (hence describing more particular embodiments and particular features as disclosed herein) without departing from the disclosure of the invention.

As used herein, the term “comprises” will take its usual meaning in the art, namely indicating that the component includes but is not limited to the relevant features (i.e. including, among other things).

For the avoidance of doubt, the term “comprises” will also include references to the component “consisting essentially of” (and in particular “consisting of”) the relevant substance(s).

As used herein, unless otherwise specified the terms “consists essentially of” and “consisting essentially of” will refer to the relevant component being formed of at least 80% (e.g. at least 85%, at least 90%, or at least 95%, such as at least 99%) of the specified substance(s), according to the relevant measure (e.g. by weight thereof). The terms “consists essentially of” and “consisting essentially of” may be replaced with “consists of” and “consisting of”, respectively.

Wherever the word ‘about’ is employed herein in the context of amounts, for example absolute amounts, such as weights, volumes, sizes, viscosities, diameters, power, distances, molecular weights, etc., or relative amounts (e.g. percentages) of individual constituents in a material (including concentrations and ratios), timeframes, and parameters such as temperatures etc., it will be appreciated that such variables are approximate and as such may vary by ±10%, for example ±5% and preferably ±2% (e.g. ±1%) from the actual numbers specified herein. This is the case even if such numbers are presented as percentages in the first place (for example ‘about 10%’ may mean ±10% about the number 10, which is anything between 9% and 11%).

### Method of Production

According to an aspect of the invention there is provided a method for the production of a composite layer in which photocatalytic nanoparticles are embedded in a polymer matrix, wherein the method comprises the steps of:
a. providing a substrate;
b. producing photocatalytic nanoparticles in situ by flame spray pyrolysis and depositing the nanoparticles on a surface of the substrate via aerosol deposition to produce a photocatalytic nanoparticle film on the surface of the substrate; and
c. immersing the photocatalytic nanoparticle film with a polymer solution, or a liquid polymer precursor material, to form the composite layer, wherein, the photocatalytic nanoparticle film has a thickness of from about 50 to about 5000 nm, which method is referred to hereinafter as “the method of the invention.”

The result of the method of the invention is the production of a composite layer comprising a percolating network of photocatalytic nanoparticles in a polymer matrix.

By the term “composite layer” we refer to a composite mixture of a matrix material, being a polymer, and a filling material, being the photocatalytic nanoparticles. As the filling material of the present invention is a nanomaterial, the composite layer may also be referred to as a “nanocomposite layer”. As outlined below, the composite layer may comprise two layers, being a lower layer comprising the nanoparticle film and an upper layer formed of the polymer, but absent of nanoparticles. Such a composite layer is provided by immersing the photocatalytic nanoparticle film with a liquid polymer precursor material that covers the nanoparticle film, with the thickness of the upper layer being determined by the amount of liquid polymer precursor material that covers the nanoparticle film.

The upper layer may be considered to overall be part of the composite layer since the same polymer is used, but the thickness of the upper layer should be no more than about 440 nm, such as from about 50 μm to 440 nm, for example from about 50 μm to 360 nm, to ensure that reactive oxygen species are able to diffuse away from the surface of the composite layer.

By the term “percolating network of photocatalytic nanoparticles” as used herein, we refer to a continuous nanoparticle film layer deposited on the substrate. In such a network the deposited nanoparticles are randomly distributed, but connected in such a way to form a continuous porous lattice, which pores allow for penetration of the polymer solution/liquid polymer precursor into the film.

In the context of the present invention, the percolating network of photocatalytic nanoparticles is formed by step b) via the in situ flame pyrolysis production of the photocatalytic nanoparticles and aerosol deposition of the formed nanoparticles on the substrate. Following this the polymer solution/liquid polymer precursor material is added to the surface of the nanoparticle layer formed on the substrate, which penetrates the pores of the percolating network thus resulting in the composite matrix after the polymer solution/liquid polymer has hardened/cured. The network formed from the deposited photocatalytic nanoparticles may also be referred to as a continuous percolating network.

The inventors have found that such a percolating network is advantageously achieved by the method of the invention and that other generally known methods for generated nanoparticle films do not necessarily arrive at such films.

Flame spray pyrolysis is a well-known technique in the art having good scalability with the ability to regulate the properties (size, crystallinity etc.) of the nanoparticles produced. An advantage of Flame Spray Pyrolysis is the regulation of the nanoparticles properties by controlling the process variables such as flame temperature, reactant concentration, mixing and/or flowrate (Teoh, W. Y.; Amal, R.; Mädler, L. Flame Spray Pyrolysis: An Enabling Technology for Nanoparticles Design and Fabrication. Nanoscale 2010, 2 (8), 1324).

The substrate may be placed in the flow path of the flame at a distance of from about 5 cm to about 100 cm, such as from about 5 to about 50 cm, for example about 5 to about 30 cm.

When stating that the substrate is placed in the flow path of the flame, it is meant that the surface of the substrate to be coated is oriented to be in the flow path of the flame. In particular the substrate may be oriented such that the surface onto which the nanoparticle film is to be deposited is essentially horizontal and downward facing.

The thickness of the photocatalytic nanoparticle film can be controlled by the deposition time, and in this regard the substrate may be placed in the flow path of the flame for a time of from about 1 second to about 300 seconds, such as about 1 to about 250 seconds, such as about 5 to about 120 seconds, for example about 5 to about 60 seconds.

The nanoparticle film thickness may be from about 50 to about 2000 nm, such as about 150 to about 700 nm, such as about 300 to about 600 nm.

The aerosol deposition of the in situ generated nanoparticles may occur through thermophoresis. That is to say that the substrate surface may be cooled so that the photocatalytic nanoparticles are attracted towards and coat the substrate surface. The substrate surface may be cooled by any means, but preferably is held by a holder which is water-cooled.

Following deposition on the surface of the substrate, and prior to the addition of the polymer solution/liquid polymer precursor material, the photocatalytic nanoparticle film may be stabilized in situ, such as through a flame annealing step. For example the photocatalytic nanoparticle film may be subjected to elevated temperature through flame treatment for a set period of time, such as about 5 to about 120 seconds, for example about 20 to about 40 seconds. Furthermore, for the annealing step the substrate may be placed at a distance from the flame of from about 5 cm to about 20 cm.

The photocatalytic nanoparticles may be selected from the list consisting of titanium dioxide nanoparticles, silver-titanium nanoparticles, zinc oxide nanoparticles, iron-titanium oxide nanoparticle, copper-titanium oxide nanoparticles, and mixtures thereof.

In particular the nanoparticles are photocatalytically active in the visible light spectrum range, and ideally the nanoparticles have a broad absorption band starting at about 400 nm (visible-light range) and extending into the near-infrared region of the spectrum, such as up to about 1000 nm. Such nanoparticles that can achieve this absorption/activation range include silver-titanium nanoparticles, which material is commonly referred to as “black titania”. By the term “silver-titanium nanoparticles” we refer to TiO₂ nanoparticles which have been doped with silver (Ag) atoms, thus arriving at visible-light-active Ag/TiOₓ nanoparticles, with TiOₓ often being given the term “suboxide”. Without wishing to be bound by theory, it is thought that with silver being doped into TiO₂ this introduces localized surface plasmon resonance properties in the system and shifts the peak absorption of the nanoparticles from the UV into the visible-light activation range.

The photocatalytic nanoparticles may have an average primary particle size of from about 5 nm to about 100 nm, such as from about 5 nm to about 60 nm, for example from about 10 nm to about 50 nm

By the term “primary particle size” we refer to the average size of each individual nanoparticle crystallite. That is to say that the primary particle size is the size of each individual nanoparticle spatially separated from other nanoparticles and the skilled person will understand that nanoparticles may aggregate together to form clusters and that this does not affect the size of the constituent nanoparticle crystallite sizes. The crystallite size of the nanoparticles may be measured by any term known in the art, for example x-ray diffraction (XRD).

Prior to adding the polymer solution the nanoparticle film has a porosity of from about 50 to about 99%, such as from about 60 to about 98%. The porosity of the nanoparticle film may be calculated by the mass per area and measured thickness by electron microscopy of the film. Alternatively, porosity may be measured by correlating the mass of the film per area (obtained gravimetrically) and the thickness of the film (obtained by cross sectional SEM images), taking into account the bulk density of the deposited material.

The skilled person is aware of how to calculate porosity of such nanoparticle films and examples may be found in G. Sotiriou et a., Advanced Functional Materials, Flexible, Multifunctional, Magnetically Actuated Nanocomposite Films, Vol. 23(1), 2013, 34-41.

The thickness of the composite layer may be in a similar range as to the nanoparticle film itself, such as from about 50 to about 2000 nm, such as about 150 to about 1500 nm, for example from about 150 to about 750 nm, in particular about 150 to about 700 nm, such as about 300 to about 600 nm.

The amount of polymer solution may be such that the resulting composite layer forms two layers, being a lower layer comprising the nanoparticle film and an upper layer formed of the polymer, but absent of nanoparticles. The upper layer may be considered to overall be part of the composite layer since the same polymer is used, but the thickness of the upper layer should be no more than about 440 nm, such as from about 50 μm to 440 nm, for example from about 50 μm to 360 nm, to ensure that reactive oxygen species are able to diffuse away from the surface of the composite layer.

The substrate may be composed of a material selected from the list consisting of glass, ceramics, plastic, metal, cross-linked elastomer, and mixtures thereof. For example the substrate can be a silicon substrate.

The polymer solution or liquid polymer precursor material may be applied to the nanoparticle film via a spin coating, cast coating, slot coating, spray coating, or dip coating.

When applying the polymer solution or liquid polymer precursor material the substrate may be oriented such that the surface to be coated is essentially in a horizontal and upward position.

The polymer may be a water-insoluble polymer, optionally wherein the polymer is selected from the list consisting of poly(dimethyl siloxane) (PDMS), poly(urethane), poly(methylmethacrylate) (PMMA), poly(ethylene), poly(propylene), poly(lactic-co-glycolic acid) (PLGA), co-polymers of any of these polymers, and mixtures thereof.

After application of the polymer solution/liquid polymer precursor the polymer may undergo a heating or curing step. For example, when the polymer is applied in solution, after application the layer can be heated to evaporate the solvent leaving the polymer. Alternatively, when applied as a liquid polymer precursor this may be applied to the surface and may be followed by a curing step at elevated temperature, optionally wherein the polymer precursor undergoes cross-linking.

The composite layer may be formed directly on the surface of the substrate, or the substrate may comprise a sacrificial coating layer onto which the composite layer is formed, wherein following composite layer formation the sacrificial layer may be removed to arrive at a free-standing composite layer film.

The sacrificial layer may be composed of a water-soluble polymeric material, such as a polymer selected from the list consisting of poly(vinyl pyrrolidone) (PVP), poly vinyl alcohol (PVA), poly(ethylene glycol) (PEG), poly(acrylamides) and poly(acrylic acid) copolymers

Alternatively, the sacrificial layer may be composed of a water-insoluble material, such as a photolithography sacrificial layer, for example polydimethylglutarimide polymer blends.

The substrate may be provided with the sacrificial layer already present, or the sacrificial layer can be formed as part of the method of the invention. For example, the sacrificial layer may be formed by coating the surface of the substrate with a polymer solution or a liquid polymer precursor material as defined above.

The sacrificial layer polymer solution/liquid polymer precursor material can be coated on the surface of the substrate via spin coating, cast coating, slot coating, spray coating, or dip coating.

After production of the composite film on the sacrificial layer, the coated substrate may be immersed in water to dissolve the sacrificial layer arriving at a freestanding composite layer.

As used herein, the term “water-insoluble polymer” refers to a polymer having a solubility in aqueous solvents, such as water, at about 25° C. of less than about 0.1 mgmL⁻¹.

### Composite Layer and Coated Articles

According to another aspect of the invention, there is provided a composite layer obtained from or obtainable by the method of the invention.

There is also provided a composite layer comprising a percolating network of photocatalytic nanoparticles in a polymer matrix, wherein the composite layer has a thickness of from about 50 to about 5000 nm.

The composite layer may comprise any of the features of the composite layer as outlined in the method of the invention.

The resulting composition layer arrived at by the method of the invention may have a high homogeneity of nanoparticles with a high content of nanoparticles. In this regard the photocatalytic nanoparticles may be present in an amount of from about 2 to about 60 vol. % of the composite layer, such as from about 10 to about 50 vol. % of the composite layer, for example from about 20 to about 45 vol. % of the composite layer.

The composite layer may have a thickness of from about 50 to about 2000 nm, such as about 150 to about 1500 nm, for example from about 150 to about 750 nm, in particular about 150 to about 700 nm, such as about 300 to about 600 nm.

The polymer of the polymer matrix may be a water-insoluble polymer, optionally wherein the polymer is selected from the list consisting of poly(dimethyl siloxane) (PDMS), poly(urethane), poly(methylmethacrylate) (PMMA), poly(ethylene), poly(propylene), poly(lactic-co-glycolic acid) (PLGA), co-polymers of any of these polymers, and mixtures thereof.

The composite layer may be comprised of two layers, being a lower layer comprising the nanoparticle film and an upper layer formed of the polymer, but absent of nanoparticles.

The upper layer may be considered to overall be part of the composite layer since the same polymer is used, but the thickness of the upper layer should be no more than about 440 nm, such as from about 50 μm to 440 nm, for example from about 50 82 m to 360 nm, to ensure that reactive oxygen species are able to diffuse away from the surface of the composite layer.

The composite layer may be deposited on a substrate, optionally wherein the substrate is may be composed of a material selected from the list consisting of glass, ceramics, plastic, cross-linked elastomer, and mixtures thereof.

The substrate may be a peelable backing layer, such as a plastic peelable backing layer. That is to say, the composite layer may be deposited on a substrate from which it can be peeled by the end user and applied to another surface so as to provide photocatalytic disinfectant properties to the surface applied to, or any of the advantageous properties outlined herein.

The substrate may alternatively be made of a soluble material, such as a water-soluble or organic solvent-soluble material, which allows for the substrate to be dissolved by the end used to free the composite layer. Suitable soluble materials may be selected from the list consisting of poly(vinylpyrrolidone), poly(vinylalcohol), poly(styrene), poly(ethylene), poly(urethane), poly(dimethylsiloxane), and mixtures thereof.

According to a further aspect of the invention, there is provided an article coated with a composite layer as defined herein.

The coated article may be a medical article, such as a medical tube (for example a catheter, or an endotracheal tube), a ventilator, an implant or a wound mesh. However, as well as medical applications the inventors have found that the composite layer may have wide-reaching applications where antimicrobial surface functionality is advantageous. Therefore, the article may be a surface that is a “high-touch object”, i.e. an object that is frequently touched by different members of the public on a daily basis and is a source of transmission of microbes, such as viruses and bacteria. Exemplary high-touch objects that could be coated by the composite layer include light emitting display panels (such as automated teller machines (ATMs)), other public use touch screens, hand rails, door handles, and the like.

It is envisaged that the coated article may be arrived at by either directly coating the article via the method of the invention, or the composite layer may be provided on a peelable backing substrate from which the composite layer can be peeled and applied to the surface of the article. In connection with this embodiment the composite layer may comprise an adhesive layer between the composite layer and the backing substrate, which, at least partially, remains with the composite layer after peeling off the backing substrate and, therefore, allows the composite layer to adhere to the surface of the article.

### Use

In another aspect of the invention there is provided the use of a composite layer as defined herein for providing photocatalytic disinfectant properties to a surface.

The use may be as an antimicrobial coating, such as to provide antimicrobial properties towards bacteria and/or viruses.

In particular the use may be as an antibacterial coating, such as an anti-gram positive bacterial coating, for example the use may be as an anti-staphylococcus aureus coating.

Alternatively, or additionally, the use may be as an anti-gram negative bacterial coating, for example the use may be as an anti-pseudomonas aeruginosa coating or an anti-escherichia coli coating.

### Method of Treatment

In a further aspect of the invention there is provided a method of treating and/or preventing a bacterial infection, such as a wound-related infection or catheter-associated bacterial infection, for example (in both types of infection) a staphylococcus aureus, via the use of a composite layer as defined herein.

The composite layer may be deposited on a surface of a medical device so as to be used in preventing bacterial in treating and/or preventing a bacterial infection.

For example, the composition layer may be deposited on a surface of a catheter, such as an inner surface and/or an outer surface of a catheter, preferably the outer surface.

The composite layer may alternatively be used as a wound dressing either on its own or supported on a material backing suitable for wound dressings, such as a gauze, bandage, or sponge.

The method of treatment and/or prevention may comprise a step of irradiating the coated surface of the medical device (e.g. the catheter or wound dressing) with visible light to thus produce ROS from the photocatalytic nanoparticles, which impart an anti-bacterial effect.

When the composite layer is on the surface of a catheter, the visible light may be provided via an endoscope which has been inserted through the lumen of the catheter to the desired location/depth for irradiation.

For applications in wound dressings, the light may be delivered externally.

Any suitable light source (e.g., LED) can be used to illuminate the composite layer.

The power of the light used may be from about 5 to about 100 mW cm⁻², such as from about 10 to about 75 mW cm⁻². Irradiation may take place for from about 5 to about 120 minutes, such as from about 15 to about 90 minutes.

As referred to herein, the term “treatment and/or prevention” we further include the treatment and/or prevention of a biofilm formation on the surface of the material.

### BRIEF DESCRIPTION OF THE FIGURES

FIG. 1 is a schematic showing various processes of flame aerosol deposition of nanostructured films in a single-step. The nanoparticles are generated in the flame and deposited by thermophoresis on the substrates positioned above the hot aerosol by a water-cooled holder. The substrates may be Si or glass or also polymer (e.g. polydimethylsiloxane, PDMS) coated substrates. Upon polymer infusion (e.g. by spin coating) on the fabricated films with the polymer covering precisely the nanoparticle film, robust, mechanically stable films can be generated. Upon adding a sacrificial layer on the substrate (e.g. polyvinylpyrrolidone, PVP), free-standing polymer nanocomposite films can be manufactured.

FIG. 2 (a) STEM-HAADF image and (b) elemental distribution by EDX of Ag/TiOₓ nanoparticles. (c) Normalized EELS spectrum extracted from regions A and B in FIG. 2a. (d) High-magnification HRSTEM image of Ag/TiOₓ nanoparticles showing high crystallinity of Ag and TiOₓ on the produced nanoparticles. (e) XRD pattern of flame-made TiO₂ (black line) and Ag/TiOₓ nanoparticles with different Ag content. (f) Ti 2p XPS spectra of the Ag/TiOₓ particle film.

FIG. 3 (a) Film thickness of Ag/TiOₓ films as a function of deposition time. The insets are cross-sectional SEM images of the Ag/TiOₓ nanocomposite films with t_{d}=30 s and t_{d}=60 s. (b) Cross-sectional SEM image of the Ag/TiOₓ polymer nanocomposite film. (c) AFM images of a (i) Ag/TiOₓ particle film with t_{d}=5 s, (ii) Ag/TiOₓ particle film with t_{d}=30 s, and (iii) Ag/TiOₓ polymer nanocomposite film.

FIG. 4 (a) UV-Vis diffuse reflectance spectra of Ag/TiOₓ (50% Ag/TiOₓ, grey line) and TiO₂ nanoparticles (black line). The inset is the plot of (ahv)^{1/2} versus energy (hv). (b) Photocatalytic degradation of MB by Ag/TiOₓ particle film (filled triangles), Ag/TiOₓ—polymer nanocomposite film (grey squares), TiO₂ particle film (empty triangles), and pure MB (black squares) under visible-light irradiation. (c) Superoxide radical formation measured by NBT inhibition from the Ag/TiOₓ particle (black columns) and Ag/TiOₓ polymer nanocomposite (red columns) films after 30 min and 90 min of visible-light irradiation (λ=400-600 nm). Applied irradiance: 74 mW cm⁻².

FIG. 5 (a) Logarithmic reduction (CFU mL-1) of S. aureus bacterial biofilm by the ˜360-nm thick Ag/TiOₓ particle film under visible-light irradiation as a function of composite film thickness. (b) Logarithmic reduction (CFU mL-1) of S. aureus bacterial biofilm by the Ag/TiOₓ particle film (˜360 nm) as a function of the irradiation time. (c) Reusability of the Ag/TiOₓ particle film (black columns) and Ag/TiOₓ-polymer nanocomposites (red columns) against S. aureus bacterial biofilm (tir=15 min, irradiance=74 mW cm −2). (d) Logarithmic reduction of different bacteria strains (E. coli, P. aeruginosa, and S. aureus) by the Ag/TiOₓ—polymer nanocomposite films. Each data point represents the mean of three biological replicates (each biological replicate was performed with three technical replicates). The error bars represent the standard deviation of these biological replicates.

FIG. 6 (a) Cell viability setups for direct and indirect contact. Cell viability determined from the resazurin assay as a measure of cytotoxities of the Ag/TiOₓ particle films (black columns) and Ag/TiOₓ polymer nanocomposites (red columns) in (b) direct and (c) indirect contact with A549 cells for 24 h. The cytotoxicity of the TiO₂ particle film, TiO₂ polymer film, Si substrate, and PDMS-coated substrate is also presented. Error bars are calculated as the standard error of the mean (n=3).

FIG. 7 is schematic illustration of flame aerosol deposition and mechanical stabilization (in situ annealing) of nanocomposite layers on silicon substrate, with an outline of the illumination of the films provided by visible light for anti-bacterial purposes.

FIG. 8 shows the XRD patterns of as-deposited films made by the process of the invention in comparison with Ag/TiOₓ nanoparticles.

FIG. 9 shows a schematic illustration of polymer film formation.

FIG. 10 shows SEM images of nanoparticle films before annealing (10a) and after annealing (10b) highlighting that the films retain their high porosity even after the annealing step.

FIG. 11 shows the photocatalytic activity of composite films when deposited on Si-substrates.

FIG. 12 shows the representative initial absorbance transformation spectra of NBT for the Ag/TiOₓ particle film and its polymer nanocomposite after 30 and 90 min of visible-light irradiation.

FIG. 13 details the fluorescence intensity spectra of aminophenyl fluorescein radical reporter (FIG. 13), which shows no evidence of OH radical formation once visible-light irradiation is ceased.

FIG. 14 details the evaluation of biofilm growth on the top of the films using the crystal-violet method.

FIG. 15 shows SEM images of the composite films.

FIG. 16 a) evaluates the effect of Ag⁺ ion release (FIG. 16a) and applied light dose alone (i.e., with no nanoparticles) and b) shows that variations over irradiation time on biofilm killing was negligible.

FIG. 17 shows the logarithmic CFUs reduction of nanocomposite films (filled bars) after 15 min and 90 min of visible-light irradiation with the polymer-infused films retaining their antibiofilm activity through logarithmic CFUs reduction even after their fourth cycle, while the nanoparticle films (open bars) significantly lost their activity after the third cycle due to nanoparticle removal during the washing steps.

FIG. 18 verifies the nanoparticle removal shown in the results of FIG. 17 through SEM analysis.

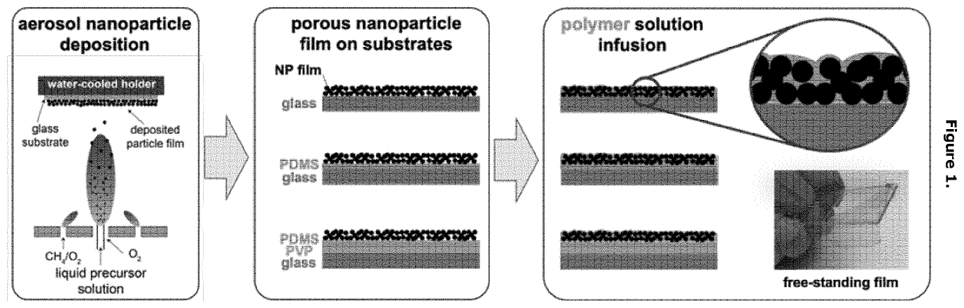

### EXAMPLES

### Nanoparticle Synthesis and Film Deposition

A flame-spray pyrolysis (FSP) reactor was used for the synthesis and in situ deposition of Ag/Ti on Si substrates of dimension 5×5 mm² mounted on a water-cooled substrate holder. Different concentrations of Ag/Ti (in wt %), such as 5%, 10%, 20%, 30%, and 50%, were used in the synthesis of nanocomposite films, and the photocatalytically optimal films having a Ti content of 50 wt. % were chosen for further investigations. The precursor solution of Ti and Ag was fed to the FSP.

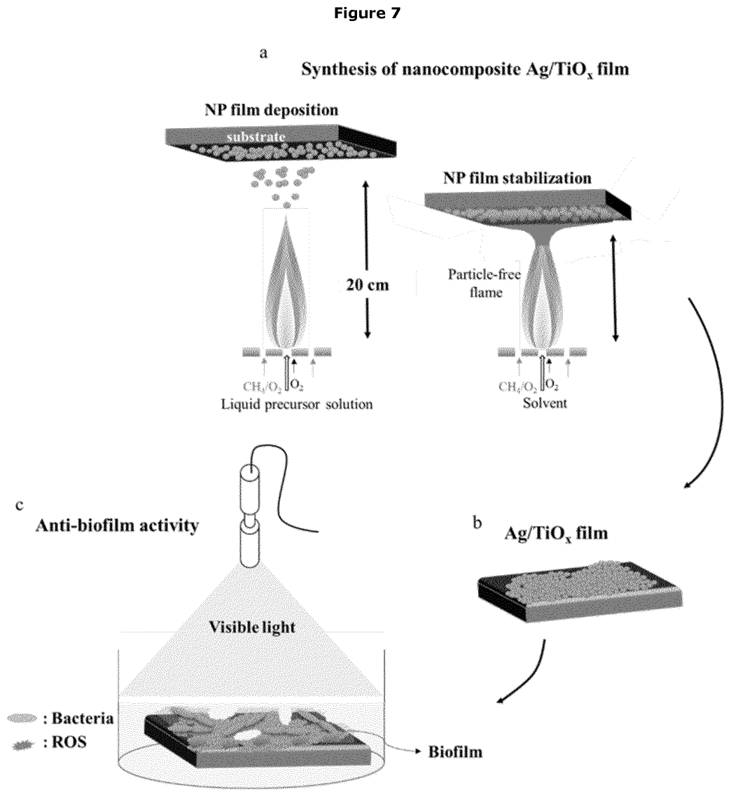

Silver acetate (Sigma-Aldrich, purity>99%) and titanium isopropoxide (TTIP, Aldrich, purity>97%) were diluted in a 1:1 mixture of 2-ethylhexanoic acid (Aldrich, purity>99%) and acetonitrile (Aldrich, purity>99.5%) with a total metal (Ti and Ag) concentration of 0.16 M. The solution was supplied at a rate of 8 mL/min through the FSP nozzle and dispersed to a fine spray with a supply of oxygen at the rate of 5 L/min (pressure drop 1.5 bar). The substrate holder was placed 20 cm above the burner for the deposition of nanoparticles, and different deposition times of 5, 15, 30, and 60 s affecting the thickness of the nanoparticle film were used. These films were mechanically stabilized by in situ annealing with impinging flow of a particle-free ethanol spray for 30 s at a constant height of 15 cm above the burner. The flow rates of dispersion oxygen and ethanol feed were 3 L/min and 12 ml/min, respectively. The as-prepared nanoparticles were collected with a vacuum pump onto a water-cooled glassed-fiber filter placed at 77 cm above the flame. A schematic illustration of flame aerosol deposition and mechanical stabilization (in situ annealing) of nanocomposite layers on silicon substrate are shown in FIG. 7.

For comparison, TiO₂ films were also prepared as follows: TTIP (Aldrich, purity>97%) was diluted in xylene at a concentration of 0.5 M. The solution was supplied at a rate of 5 mL/min through the FSP nozzle and dispersed to a fine spray with a 5 L/min of oxygen flow (pressure drop 1.5 bar) on Si substrates of dimensions 5×5 mm² mounted on a water-cooled substrate holder. The substrate holder was placed 20 cm above the burner for nanoparticle deposition. Thereafter, the annealing step for the stabilization of the nanoparticles was performed, as described above. The deposition time was varied from 15 s to 60 s.

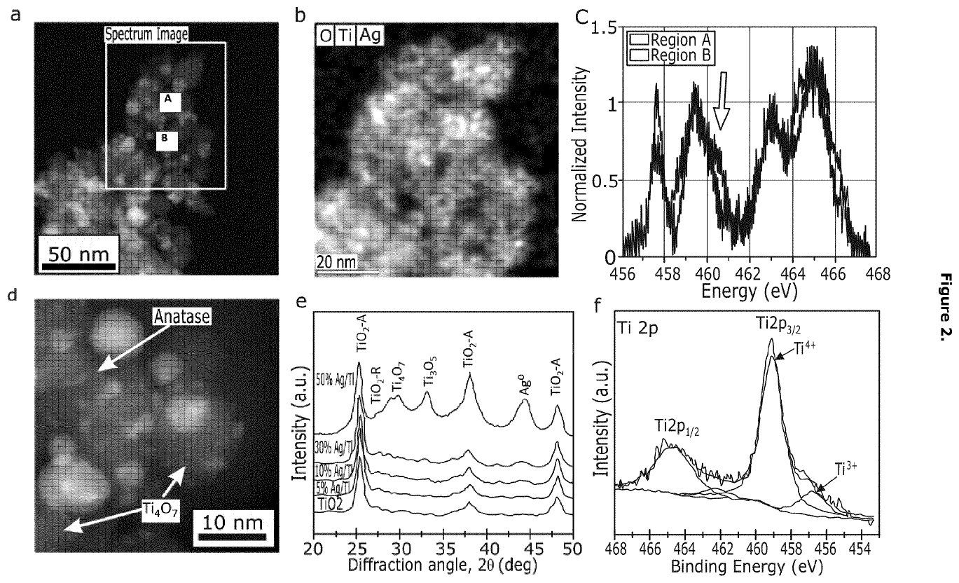

FIG. 2a shows a high-angle annular dark-field scanning transmission electron microscopy (HAADF-STEM) image of Ag/TiOₓ (50% Ag/Ti) nanoparticles. The nanoparticles exhibit agglomerated/aggregated morphology characteristic for flame-made nanoparticles, while Ag nanoparticles appear brighter than TiOₓ nanoparticles (Z-contrast). A selected area in FIG. 2a (yellow square) was scanned to obtain simultaneous hyperspectra datacubes of energy dispersive X-ray (EDX) spectroscopy and monochromated electron energy loss spectroscopy (EELS). FIG. 2b shows a false-color composite map of the elemental distribution of O, Ti, and Ag obtained from EDX spectroscopy. This map corroborates the Z-contrast observed in the FIG. 2a and unambiguously confirms the presence of TiOₓ and Ag nanoparticles. However, EDX and Z-contrast imaging cannot distinguish the Ti-suboxide phases because they have nearly identical compositions. Therefore, we considered the simultaneously-acquired monochromated EELS spectra, shown in FIG. 2c. These spectra were obtained by integrating the spectra from the hyperspectral datacubes over boxes A and B (see FIG. 2a), subtracting the pre-edge background, and then deconvolving the spectra with the simultaneously-acquired low-loss EELS spectrum (also integrated over the same boxes). This EELS experiment was configured to record Ti L2,3 edges with an energy resolution of approximately 220 meV, allowing a detailed investigation of the transitions of Ti 2p1/2 and 2p3/2 electrons to unoccupied 3d orbitals. These edges have been extensively studied with EELS, and it is accepted that the fine structural features can be used to distinguish between different TiOx polymorphs. In anatase, the oxygen octahedron surrounding the Ti metal atom is slightly distorted, reducing a perfect Oh point-group symmetry to D2d. This results in a slight splitting of the peak corresponding to the transitions of Ti 2p3/2 electrons to unoccupied eg states, which itself arises from crystal splitting. This can be experimentally resolved as a shoulder on the eg peak located at 460.3 eV, which can be seen in FIG. 2c (black arrow). The two integrated spectra shown in FIG. 2c were chosen from the spectrum image (FIG. 2a) to highlight the differences in this feature due to different TiOx particles captured in the experimental field-of-view. The spectrum from region A has a striking resemblance to anatase, whereas that from region B does not correspond well with the other EELS spectra reported in the literature. This suggests that the spectrum from region B arises from the less studied Ti-suboxide phases.

Mixing of anatase and suboxide TiOₓ phases is also confirmed by the high-resolution HAADF-STEM image shown in FIG. 2d. Although this image is obtained from a different region of the sample, the HAADF detector was configured same to that in FIG. 2a, allowing us to deduce the regions of higher pixel intensity corresponding to the presence of Ag nanoparticles. However, the observation of multiple lattice planes from the TiOₓ-rich particles is more important. We observed two particles with lowest-order planar distances measured at 6.20 Å based on the local fast Fourier transforms. These indices fit more closely as the (010) and (01 0̅) lattice planes in Ti₄O₇. We also observed one particle with a planar distance of 1.89 Å, which corresponds well with the (020) and (02 0̅) lattice planes in anatase. These particles are labelled accordingly in FIG. 2d.

Powder X-ray diffraction (XRD) analysis of the Ag/TiOₓ nanoparticles with different Ag content also detected Ti-suboxides, as shown in FIG. 2e. For pure TiO₂ nanoparticles (black color), the peaks in the XRD pattern correspond to the characteristic anatase (JCPDS 021-1272) and rutile TiO₂ phases (JCPDS 021-1276), which is in agreement with the literature. However, for an increasing content of Ag, the XRD patterns exhibit two significant changes.

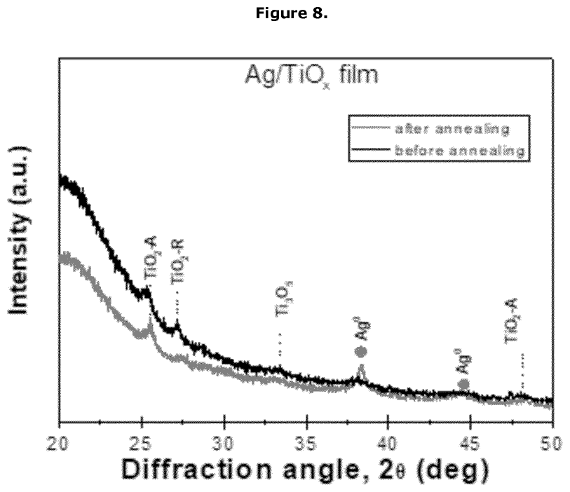

The peaks corresponding to Ag emerge at 2θ angles of ˜38° and 44°, indicating the presence of metallic Ag nanoparticles. Furthermore, with the increasing content of Ag, several broader peaks are detected at 33° (attributed to Ti₃O₅), 28.5°, and 29.5° (attributed to Ti₄O₇ or other suboxide layer such as TiₓO₂ₓ₋₂) with increasing intensity. Analogous features of Ti₃O₇ and Ti₄O₇ layers in Ag/Pt/TiO₂ systems, which are indicative of SMSI, have been reported. Our results show that such Ti-suboxide formation becomes even stronger during the flame synthesis of Ag/TiOₓ nanoparticles for the Ag/Ti ratio>20%, with 50% of the Ag/Ti sample having the highest content of TiOₓ species. The XRD pattern of the as-deposited film with the same composition as the 50% Ag/Ti sample appears similar to Ag/TiOₓ nanoparticles (FIG. 8) with slightly lower anatase content and larger size of Ag particles compared to Ag/TiOₓ nanoparticles, owing to high temperatures during in situ flame annealing. To further characterize the formation of the Ti-suboxide species in the produced Ag/TiOₓ nanoparticles, we performed X-ray photoelectron spectroscopy (XPS) on the 50% Ag/Ti sample deposited as a film. The Ti 2p XPS spectrum (coupled with Gaussian fits) of the Ag/TiOx nanocomposite film is shown in FIG. 2f. The binding energies at 456.9 and 459.1 eV are attributed to Ti-suboxide (Ti³⁺) and TiO₂ (Ti⁴⁺), respectively.

### Fabrication of the Ag/TiOₓ-polymer Nanocomposite Film

For the preparation of Ag/TiOₓ-polymer nanocomposite films, polymer-coated substrates (76×52 mm²) were produced before the deposition of nanoparticles. More specifically, glass slides used as substrates were coated with a PDMS polymer (polydimethylsiloxane) layer by spin-coating a 10:12.68:1 wt % solution of a commercially available PDMS from Dow chemicals (SYLGARDR 184) PDMS:acetonitrile:curing agent first at 100-500 rpm s⁻¹ for 10 s and then at 1000-4000 rpm s⁻¹ for 50 s. This step was followed by the curing of PDMS on a hot plate at 100° C. for 2 h. The Ag/TiOₓ nanoparticles deposition on the polymer-coated substrates was performed in situ in the FSP reactor, as described above. For nanoparticle deposition, the substrate holder was placed 20 cm above the burner, and the deposition time was 15 s. In situ flame annealing was performed at 20 cm above the burner under cooling conditions using a particle-free xylene flame. The stabilization of the nanoparticles onto the polymer layers was achieved by spin-coating the 1:12.68:1 wt % solution of PDMS:acetonitrile:curing agent onto the existing nanocomposite film first at 100-500 rpm s⁻¹ for 10 s and then at 1000-4000 rpm s⁻¹ for 50 s. This was followed by the curing of PDMS on a hot plate at 100° C. for 2 h. FIG. 9 shows a schematic illustration of polymer film formation.

To remove the polymer film from the substrate, a sacrificial layer of water-soluble polyvinylpyrrolidone (PVP) film was performed before the first PDMS layer coating. The film on the substrate was submersed in milli-Q H₂O, and then the nanocomposite polymer film was separated within 5 min of submersion and removed with a tweezer. The polymer nanocomposite film was cut in pieces of 6×6 mm² using a 3D-printed holder and a glass cutter.

### Nanoparticle and Film Characterization

X-ray diffractions (XRD) patterns of the films and collected nanoparticles were performed by a Rigaku MiniFlex diffractor using Cu Kα1 radiation (1.5406 Å). The film thickness was estimated by scanning electron microscopy (SEM) with focused ion bean (gallium source) using a FEI Nova 200 dual beam system. STEM, monochromated EELS, and EDX experiments were conducted on a double-aberration-corrected Themis Z microscope (Thermo Fisher) operated at 300 kV. This instrument was equipped with a monochromater, which was excited and tuned to an energy resolution of 220 meV to obtain the EELS results shown in FIG. 2. A SuperX EDX detector (Thermo Fisher) and Quantum Gatan Image Filter (Gatan, Inc.) running on a dual-EELS mode were operated simultaneously for the acquisition of the hyperspectral dataset presented in FIG. 2. The spectroscopy experiments were conducted using a probe current of 420 pA, a convergence angle of 21.4 mrad, and a collection angle of 23 mrad, while a probe current of 70 pA was used for HRSTEM. Atomic force microscopy (AFM) images were recorded with a Bruker

Dimension Icon microscope. The X-ray photoelectron spectroscopy (XPS) was performed using a Physical Electronics (PHI) system equipped with PHI Quantera II. A 300 W xenon lamp (Max 350, Asahi Spectra) equipped with a UV-Vis mirror module (300-600 nm) was used as a light source. Visible-light illumination (λ=400-600 nm) was performed using a 25 mm long-pass filter (>400 nm) (Asahi Spectra). The light was delivered to the samples by a quartz light guide equipped with a quartz collimator.

Flame aerosol nanoparticle deposition on substrates facilitates a fine control of the thickness of the deposited nanoparticle film by simply controlling the deposition duration. To control the thickness of the Ag/TiOₓ films on Si substrates, various deposition times (t_{d}), that is, 5-60 s, were examined for the sample with the highest Ti-suboxide content (50% Ag/Ti).

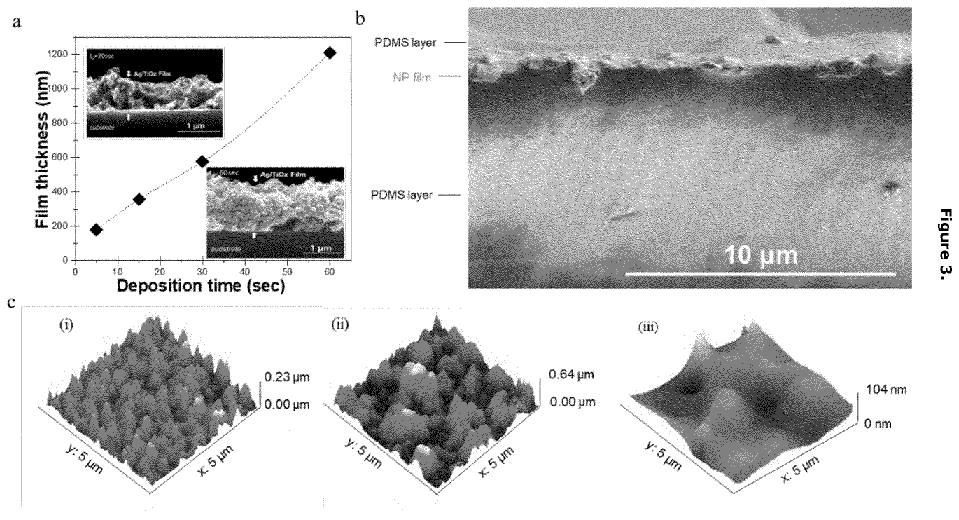

The Ag/TiOₓ film thickness was estimated from the cross-sectional SEM images. FIG. 3a shows the film thickness as a function of deposition time t_{d}. Increasing the deposition time from 5 to 60 s increases the thickness of Ag/TiOₓ films from ˜180 to ˜1200 nm. The cross-sectional SEM images of Ag/TiOₓ films at t_{d}=30 s and t_{d}=60 s are shown as insets in FIG. 3a, highlighting their porous structures.

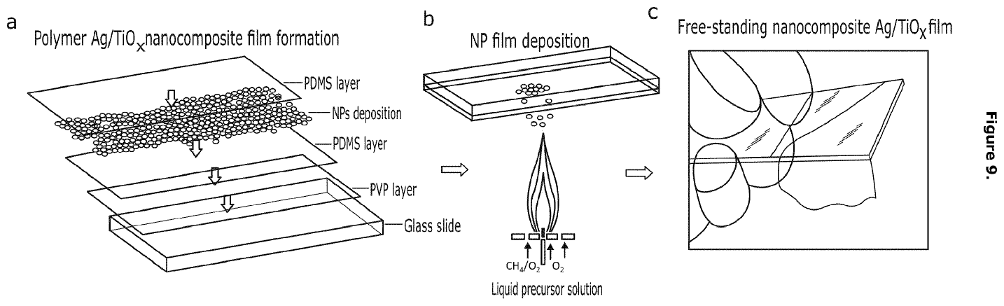

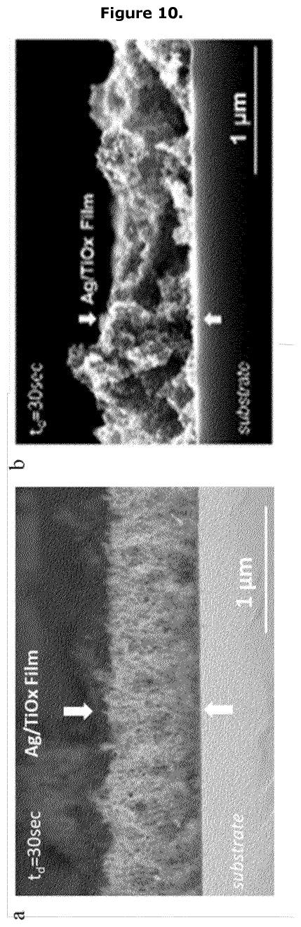

The structural stability of the deposited nanoparticle film is enhanced by the in situ flame annealing step (FIG. 10) while the films retain their high porosity even after the annealing step. Their porous structure allows the infusion of polymer solutions upon spin coating, forming polymer nanocomposite films. By controlling the polymer concentration and spin-coating conditions, a polymer layer of the same thickness as the nanoparticle film can be added onto the Ag/TiOₓ nanoparticles film surface. This results in polymer nanocomposite films with a minimal polymer layer on top of the deposited nanoparticles, as shown in FIG. 3b. The top polymer (PDMS) layer precisely covers the porous nanoparticle film.

FIG. 3c shows AFM images of the three-dimensional (3D) configuration of Ag/TiOₓ films (50% Ag/Ti) deposited on Si-substrates for (i) t_{d}=5 s and (ii) t_{d}=30 s. The measurements were performed in an area of 5 μm×5 μm, and a dense distribution of Ag/TiOₓ nanoparticles was observed in both cases. The roughness of the Ag/TiOₓ film (t_{d}=5 s) did not exceed 230 nm and large grains were obser1ved on the surface. The surface roughness increased with longer deposition time (e.g., t_{d}=30 s). In contrast, the surface of the polymer-infused film shown in FIG. 3c(iii) is significantly smoother than the corresponding particle films because of the presence of the thin PDMS layer that barely covers the nanoparticle film.

### Estimation of Band-gap Energy

UV-Vis diffuse reflectance spectra were recorded using a UV-Vis spectrophotometer system Specord 210 Plus (Analytik Jena) equipped with integrating sphere assembly in the wavelength range of 300-800 nm. The band-gap energy (Eg) values were calculated using the Kübelka-Münk equation.

### Evaluation of Photocatalytic Activity

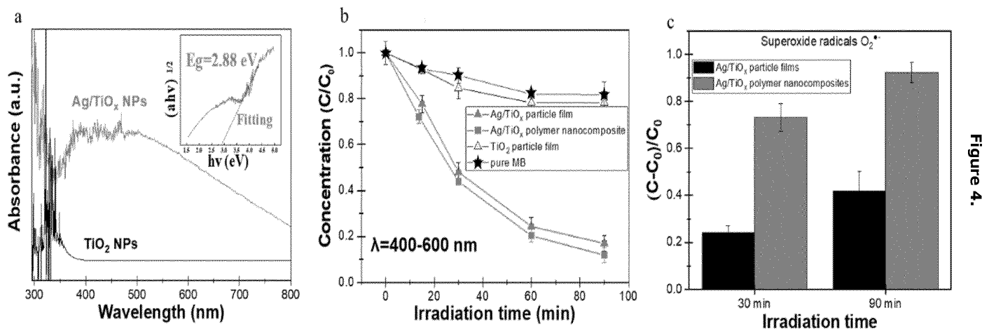

Methylene Blue (MB) is an organic azo dye frequently used as a model molecule to study the performance of photocatalysts. The experiments of MB degradation were conducted at 298 K. Typical MB degradation involves either the Ag/TiOₓ nanocomposite films or the Ag/TiOₓ-polymer films, and the photocatalytic reactions were performed into well-plates. The pH of MB was adjusted to 9.0 using NaOH, and 2 mL of the solution was added to the well-plate containing the film. Before illumination, the mixture was kept in dark for 30 min to reach adsorption equilibrium on the semiconductor surface. During the photocatalytic reaction, a standard amount of the sample (500 μL) was withdrawn from the reactor at specific intervals. Decolorization of MB was determined by monitoring the change in optical absorption at 660 nm using a Specord 210 Plus UV-Vis spectrophotometer operating in the wavelength range of 400-700 nm. The sample was measured in a 3 mL quartz cuvette with an optical path of 1 cm. According to the standard curve of concentration and absorption, the value of C/C₀, which indicates the decomposition efficiency, was calculated. Each experiment was conducted three times. For comparison, pure TiO₂ films or polymer TiO₂ films were used as a reference photocatalyst film under visible light. The reusability of both the Ag/TiOₓ nanoparticle films was investigated as mentioned above. FIG. 4a shows the diffuse reflectance ultraviolet-visible (UV-Vis) spectra of Ag/TiOₓ nanoparticles (50% Ag/Ti, grey line) and pure TiO₂ (black line). In the visible-light range, pure TiO₂ nanoparticles have almost no absorbance, while the Ag/TiOₓ nanoparticles exhibit a broad absorption band. For both samples, the absorbance at wavelengths<350 nm is attributed to the crystal phase of anatase. Moreover, a broad absorption band starting at ˜400 nm (visible-light range) and extending into the near-infrared region of the spectrum is seen for Ag/TiOₓ. This enhanced absorption band is attributed to both the formation of surface Ti³⁺ centers and the plasmonic properties of the Ag nanoparticles.

In similar TiOₓ systems, the introduction of lattice disorder narrows the optical band from 3.2 eV to 1.54 eV, which is similar to visible-light absorption band; thus, the photocatalytic capacity is enhanced in this range. The inset in FIG. 4a shows the Tauc plot of pure TiO₂ and Ag/TiOₓ nanoparticles obtained from the DRS results. The band-gap (E_{g}) values for pure TiO₂ and Ag/TiOₓ nanoparticles were 3.22 eV and 2.88 eV, respectively. T his change in E_{g} could be attributed to the presence of the surficial Ti³⁺ states and the generation of sub-band-gap energy tails from the distorted Ti-suboxide layers.

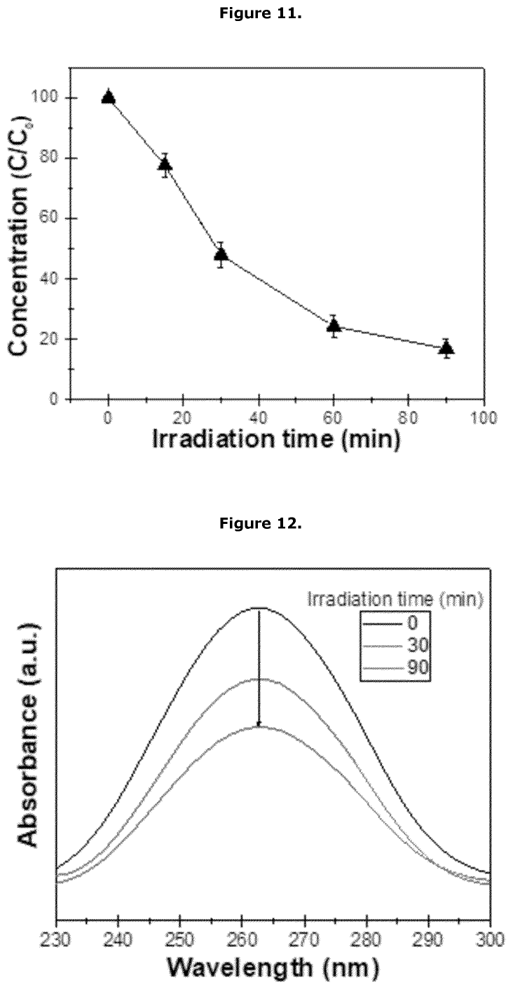

The visible-light photocatalytic properties of Ag/TiOₓ particle films (t_{d}=15 sec, 50% Ag/Ti) at ˜360 nm and the corresponding polymer-infused films were investigated using MB degradation assay. For comparison, the photocatalytic efficiency of pure TiO₂ particle films with similar thickness and MB without any sample (only irradiation) were also investigated. FIG. 4b shows the normalized MB concentration (C/C₀) of the aqueous solutions of the Ag/TiOₓ particle, Ag/TiOₓ-polymer nanocomposite, and pure TiO₂ particle films under continuous visible-light (400-600 nm) irradiation (74 mW cm⁻²) for up to 90 min. The Ag/TiOₓ particle film (filled triangles) is highly active at MB degradation under visible light (28 min half-life), while >80% of MB was degraded in 90 min of irradiation. In comparison, pure TiO₂ particle films (empty triangles) exhibited a minor catalytic efficiency under visible-light irradiation (11% of MB degradation upon 90 min irradiation). In similar systems, the presence of Ag on TiO₂ surface might enhance the degradation of MB under visible light; however, the Ag/TiOₓ films used in this study exhibit a significantly stronger photocatalytic activity due to the presence of Ti-suboxide layers. The photocatalytic activities of the dispersed Ag/TiOₓ aqueous solutions show similar results, indicating that the nanoparticles retain their photocatalytic properties when deposited on Si-substrates (FIG. 11).

The Ag/TiOₓ-polymer nanocomposite film also exhibits high efficiency in MB degradation under visible-light irradiation with 24 min of half-life and ˜90% of MB degradation within 90 min. This confirms that the presence of the thin PDMS layer on the top of the Ag/TiOₓ nanoparticle film does not affect the ROS generation and the ROS permeability through the PDMS layer. In fact, the ROS permeability through PDMS depends on the thickness of the layer. Herein, we produced additional polymer Ag/TiOₓ nanocomposite films with PDMS layers of thicknesses ˜800 nm and ˜1200 nm. These films exhibited no photocatalytic properties (data not shown), thereby confirming the dependence of ROS permeability on the thickness of a PDMS layer. Therefore, it is crucial that the PDMS layer only barely covers the nanoparticle layer to retain the photocatalytic activity of the nanoparticle film and an upper limit of 440 nm appears to apply where limited affect on ROS permeability is observed. Above this level the permeability is affected.

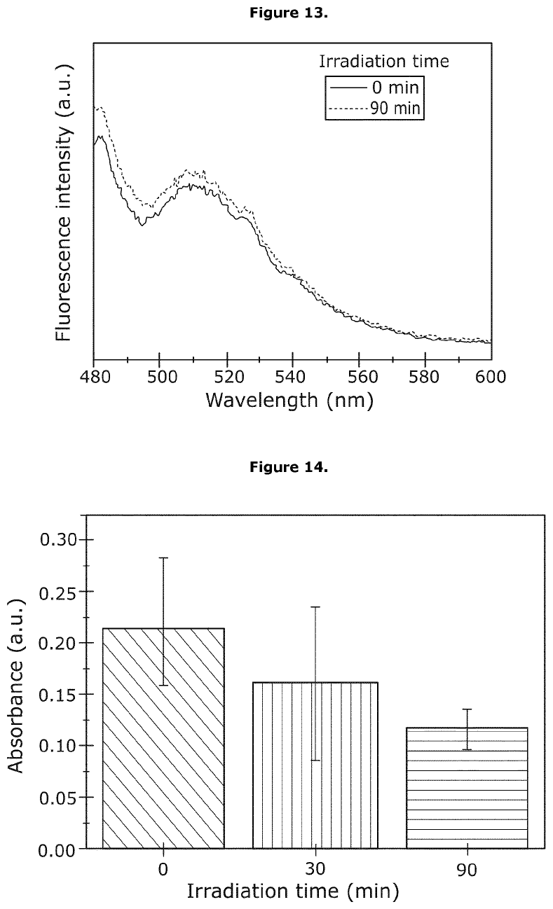

To identify the generated ROS from the photocatalytic coatings, herein we used nitroblue tetrazolium (NBT) as an organic molecule reporter. Therefore, the generation of superoxide radicals (O₂^{⋅-}) on the ˜360 nm thick Ag/TiOₓ films and their polymer-infused counterparts was investigated under visible-light irradiation. The presence of O₂^{⋅-} is quantified by measuring the absorbance of NBT, which reduces to diformazan. FIG. 4c shows the absorbance transformation of NBT for the Ag/TiOₓ particle film and its polymer nanocomposite after 30 and 90 min of visible-light irradiation, which is estimated to be 24% and 42%, respectively (the representative initial spectra is shown in FIG. 12). The absorbance transformations (in percentage) of NBT after 30 min and 90 min of visible-light irradiation for the Ag/TiOₓ-polymer nanocomposite films are higher than those of the particle films. The measurements by the aminophenyl fluorescein radical reporter (FIG. 13) show no evidence of OH radical formation after visible-light irradiation.

### Identification of ROS

The superoxide anion (O₂^{⋅-}) was generated by the nanocomposite films using the nitroblue tetrazolium (NBT) absorbance method. NBT solutions (5 μmol) were prepared in milli-Q water. The nanocomposite films were placed in 12-multiwell plates, and 2 ml of the working solution was added in each position. The resulting solution was irradiated for 30 and 90 min. NBT has an absorption peak at 260 nm, and its absorbance was obtained in the range of 230-300 nm. Radical generation was averaged over three independent experiments.

### Antibiofilm Activity of the Ag/TiOₓ Particle and Polymer Nanocomposite Films Under Visible-light Irradiation

The antibiofilm activity of the Ag/TiOₓ nanocomposite films was evaluated against gram-positive S. aureus (ATCC29213) bacteria. The bacteria were precultured in a 1:500 nutrient broth and diluted to 10⁸ colony forming units (CFUs). The films were sterilized at 210° C. for 2 h and placed on well plates. Thereafter, 1.8 mL of the bacterial suspension was added to the wells of a 12-well plate, each containing one of the sterilized films. The samples were incubated for 24 h at 37° C. for bacterial growth. The biofilm growth on the top of the films was evaluated using the crystal-violet method (FIG. 14). After incubation, the films were washed twice in phosphate buffer saline (PBS) to remove all planktonic bacteria from the samples. Three parallel tests were conducted in the experiments to ensure accuracy. The films were placed in new well plates, 1 mL of PBS was added to each plate, and the films were irradiated with visible light. The intensity of the light reaching the films was measured with a power meter (Thorlabs). After establishing the irradiation times (15, 30, 60, and 90 min), the nanocomposite films and the solution were vortexed and sonicated in 1 mL of PBS for the biofilm detachment.

The resulting suspensions were serially diluted, and the suspensions were placed on agar plates and incubated at 37° C. for 20 h to determine the CFUs (see FIG. 7c for a schematic illustration of the biofilm experiment of the Ag/TiOₓ nanocomposite film). Control samples containing the silicon substate without the nanocomposite films were also tested. The effect of the applied light dose on the antibiofilm activity of the films was also investigated in the dose range of 15-74 mW cm⁻².

Similarly, the antibiofilm capacity of the Ag/TiOₓ-polymer nanocomposite films was evaluated against gram-positive S. aureus (ATCC29213) and gram-negative P. aeruginosa and E. coli bacteria. The control samples containing the PDMS layer without the nanocomposite films were also tested. The CFUs counts on the samples were averaged and the antibacterial activity was calculated on a logarithmic-reduction scale.

### Cell Culture and Cytotoxicity Assessment

Human A549 cells (lung adenocarcinoma epithelial cell line) (ATCC CCL-185) were cultured in DMEM (GIBCO) with 10% FBS (GIBCO) and 50 U/mL penicillin-streptomycin (ThermoFischer). For the Si substrates, the cells were grown until 90% of confluent and 15,000 cells were seeded into a 48-well plate (Sarstedt) in 300 μL of a medium. The cells were incubated for 16 h and washed with PBS. Thereafter, 400 μL of the medium was added. For the direct contact assay, the test substrate was placed gently into the well with the coated side down. For the indirect contact assay, the test substrate was placed in a 3D-printed well insert. The protocol was adjusted for the glass substrates due to their larger size than the Si-substrates. A custom 3D-printed well insert was placed in a 24-well plate (Sarstedt) to leave out a central square of dimensions 8.5×8.5 mm² from the well plate plastic for cell adhering. For cell attachment, 355 μL of the medium containing 30,000 cells was incubated for 16 h. The cells were washed with PBS and 355 μL of the fresh medium was added to the wells. The substrates were either placed directly onto the cell monolayer or suspended in the medium above the cells in a 3D-printed insert. After 24 h of incubation with the substrates in both cases, the substrates (and well-inserts) were removed, resazurin was added, and the plates were incubated for further 4 h. From each well, 200 μL of the medium was then transferred into a 96-well plate. Furthermore, the fluorescence was measured using an LS55 luminescence spectrometer (Perkin Elmer) with excitation and emission wavelengths of 540 nm and 590 nm, respectively. All incubation steps were performed at 37° C. and 5% CO₂. The Standard Triangle Language files of 3D-printed components are provided in the SI. The 3D printing was performed using a photon 3D printer (Anycubic) with clear PrimaCreator value resin (Prima Printer Nordic AB).

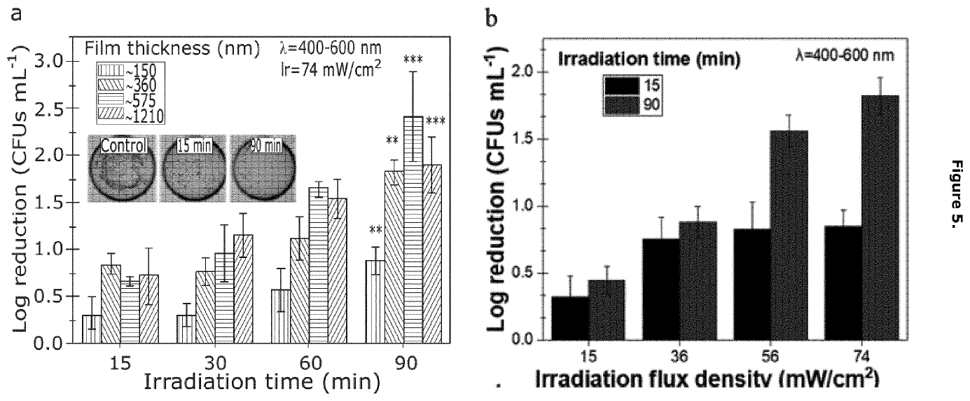

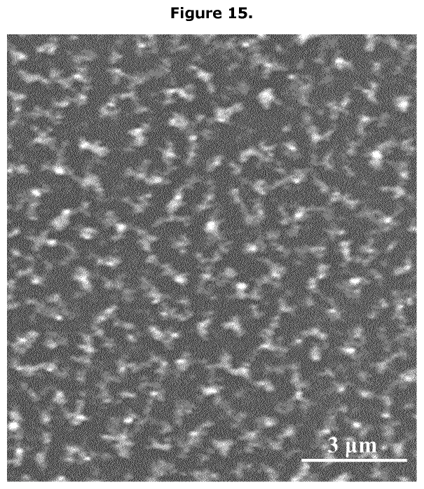

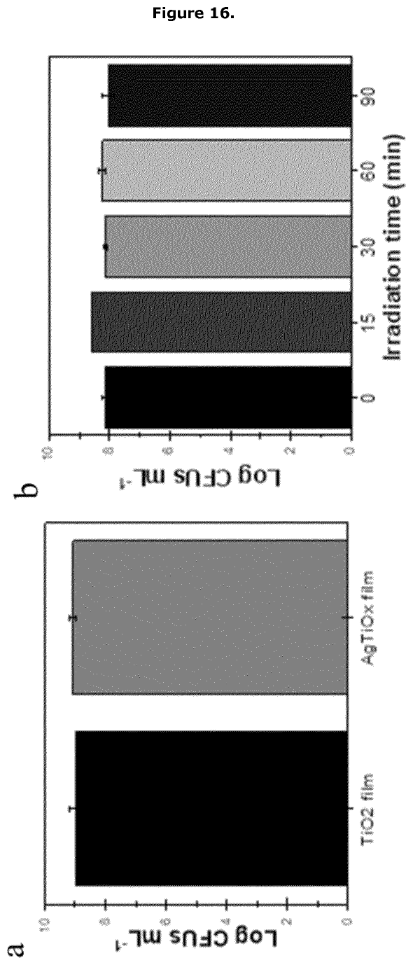

To study the destruction of biofilms triggered by visible-light irradiation, we incubated the particle films with S. aureus—a pathogen frequently found in catheter-associated infections. The biofilms were grown in the dark for 24 h and irradiated with visible light (15-74 mW cm⁻²) for 15-90 min. The bacteria still present in the biofilm were subsequently retrieved and quantified by counting their colony forming units (CFUs) per milliliter of the sample (CFUs mL⁻¹). FIG. 5a shows the logarithmic reduction of S. aureus bacteria (CFUs mL⁻¹) on the Ag/TiOₓ particle films with different film thicknesses upon visible-light irradiation for 15 and 90 min. With the increase in Ag/TiOₓ film thickness and irradiation time (from 15 min to 90 min), the CFUs of S. aureus bacteria reduced significantly. The antibiofilm activities of the films with thicknesses ˜360-1210 nm were very similar for all irradiation durations with up to a 2-log CFU reduction. However, the thinnest film exhibited the least antibiofilm activity, which is probably due to the partial surface coverage of the substrates, as verified by the SEM analysis (FIG. 15). The effect of the dose of visible light on the antibiofilm activity of the Ag/TiOₓ particle films was also investigated for the ˜360 nm thick film sample, as shown in FIG. 5b. It can be seen the antibiofilm activity is enhanced with increasing visible-light dose. FIG. 5b (inset) also shows the photographs of the petri dishes used to quantify the CFUs mL⁻¹. It should be noted that the effect of Ag⁺ ion release (FIG. 16a) and applied light dose alone (i.e., with no nanoparticles) on biofilm killing was found to be negligible (FIG. 16b).

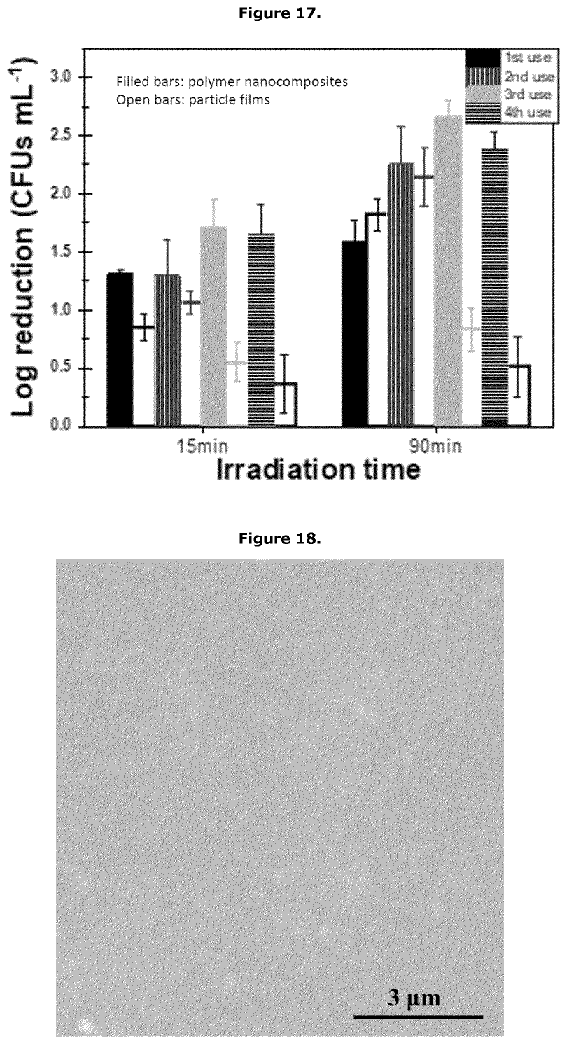

The triggered antibiofilm activity of the polymer-infused Ag/TiOₓ nanocomposite films was also investigated. The logarithmic CFU reduction of S. aureus biofilms by the Ag/TiOₓ particle and Ag/TiOₓ nanocomposite films upon 15 min of visible-light irradiation for up to 4 cycles is shown in FIG. 5c. Similarly, the logarithmic CFUs reduction after 90 min of visible-light irradiation is shown in FIG. 17. During the first cycle, the polymer-infused Ag/TiOₓ films exhibited similar, or even slightly better, antibiofilm performance compared to the particle films counterparts. However, the polymer-infused films retained their antibiofilm activity even after their fourth cycle, while the nanoparticle films significantly lost their activity after the third cycle due to nanoparticle removal during the washing steps, as also verified through SEM analysis (FIG. 18). This confirms that the thin PDMS layer on the nanoparticles film (i.e. a layer on top of the nanoparticle film that does not contain nanoparticles) increases the stability and durability of the films, and it retains their antibiofilm activity over several cycles, with the optimum thin PDMS layer being no greater than 440 nm with a lower limit of 50 μm being ideal to achieve stability and durability. The triggered antibiofilm activity of the polymer-infused Ag/TiOₓ nanocomposite films was also investigated against E. coli and P. aeruginosa bacterial biofilms. Their logarithmic CFU reduction is presented in comparison to their activity against S. aureus biofilms (FIG. 5d), revealing that the generated ROS have the capacity to destroy biofilms from different microorganisms.

### Biocompatibility of Ag/TiOₓ Films

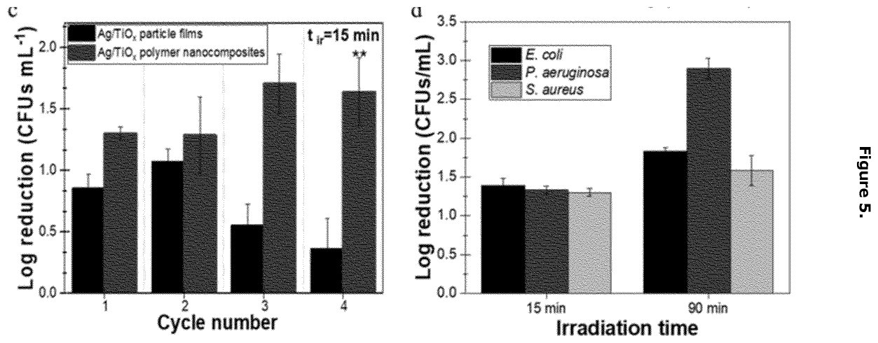

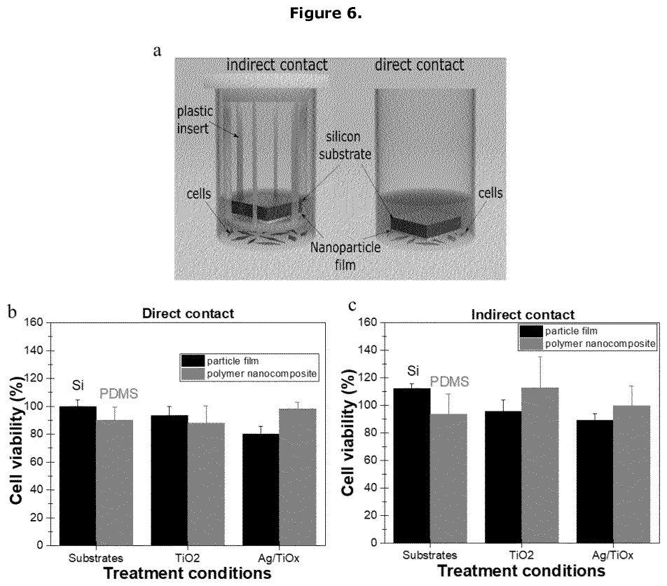

When designing any coating for biomedical applications, the characterization of its biocompability should be essentially considered. It is well known that Ag nanoparticles exhibit significant cytotoxicity, while unilluminated titania is relatively biocompatible. To assess the cytotoxicity of the Ag/TiOₓ nanocomposite and polymer films prepared here, two assays, that is, direct contact and indirect contact, were performed on lung epithelial cell line A549 (e.g., direct exposure simulating endobronchial intubation) (FIG. 6a) as described above in the section titled “Cell culture and cytotoxicity assessment”. These should evaluate the intrinsic cytotoxicity due to the direct contact of the particle and polymer films with the cells and substances leaching from the films into the cell culture medium, respectively.

FIG. 6b,cshows the cytotoxicity results of the TiO₂ and Ag/TiOₓ films (both particle and polymer nanocomposite films) in direct and indirect contact with A549 cells for 24 h (Si and PDMS act as control). First, the PDMS layer does not particularly affect the cell viability, which corresponds well with its biocompatibility. Both pure TiO₂ particle and polymer films exhibit no cytotoxicity in both direct and indirect contact. The Ag/TiOₓ particle films exhibit the highest cytotoxicity despite relatively mild cell viability of >80%; however, this effect is completely diminished by the PDMS infusion and polymer nanocomposite fabrication. Therefore, infusing PDMS into the porous Ag/TiOₓ particle film enhances the surface biocompatibility and best surface biocompatibility was observed when the composite layer has an outer surface that does not have exposed nanoparticles, i.e. there is an upper layer comprising only PDMS. The slightly higher cytotoxicity (P<0.05, ns) of the Ag/TiOₓ films compared to that of the pure TiO₂ films may be attributed to the well-known cytotoxicity of nanosilver. The increased cytotoxicity of the nanocomposite films upon irradiation is likely due to the generation of ROS (data not shown). On the other hand, antiseptics, such as H₂O₂ (effective in higher than 3% concentration), are widely used in clinical settings for disinfection and treatment of wounds. Although H₂O₂ exhibits cytotoxicity, it is undoubtedly beneficial for chronically infected wounds, where the tissues are already damaged by the infection; thus, it outweighs any secondary damage. Similarly, the Ag/TiOₓ nanocomposite films have expectedly high therapeutic benefits when applied to medical devices.

1. A method for the production of a composite layer in which photocatalytic nanoparticles are embedded in a polymer matrix, wherein the method comprises the steps of:
a. providing a substrate:
b. producing photocatalytic nanoparticles in situ by flame spray pyrolysis and depositing the nanoparticles on a surface of the substrate via aerosol deposition to produce a photocatalytic nanoparticle film on the surface of the substrate; and
c. immersing the photocatalytic nanoparticle film with a polymer solution, or a liquid polymer precursor material, to form the composite layer, wherein, the photocatalytic nanoparticle film has a thickness of from about 50 to about 5000 nm.

2. The method according to claim 1, wherein the substrate is placed in the flow path of the flame at a distance of from about 5 cm to about 100 cm.

3. The method according to claim 1, wherein the substrate is placed in the flow path of the flame for a time of from about 1 second to about 300 seconds.

4. The method according to claim 1, wherein the polymer solution or liquid polymer precursor material is applied to the nanoparticle film via a spin coating, cast coating, slot coating, spray coating, or dip coating.

5. The method according to claim 1, wherein the photocatalytic nanoparticles are titanium dioxide nanoparticles, silver-titanium nanoparticles, zinc oxide nanoparticles, iron-titanium oxide nanoparticle, copper-titanium oxide nanoparticles.

6. The method according to claim 1, wherein the photocatalytic nanoparticles have a size of from about 5 nm to about 100 nm.

7. The method according to any preceding claimclaim 1, wherein prior to adding the polymer solution the nanoparticle film has a porosity of from about 60 to 98%.

8. The method according to claim 1, wherein the substrate is composed of a material selected from the list consisting of glass, ceramic, plastic, cross-linked elastomer, and mixtures thereof.

9. The method according to claim 1 wherein the polymer in the liquid polymer solution or the liquid polymer precursor material is a water-insoluble polymer, optionally selected from the list consisting of poly(dimethyl siloxane) (PDMS), poly(urethane), poly(methylmethacrylate) (PMMA), poly(ethylene), poly(propylene), poly(lactic-co-glycolic acid) (PLGA), and mixtures thereof.

10. A composite layer made or obtainable using a method according to claim 1.

11. A composite layer comprising a percolating network of photocatalytic nanoparticles in a polymer matrix, wherein the composite layer has a thickness of from about 50 to about 5000 nm.

12. The composite layer according to claim 10, wherein the composite layer comprises two layers being a lower layer comprising the photocatalytic nanoparticles and an upper layer that is absent of nanoparticles.

13. The composite layer according to claim 12, wherein the upper layer has a thickness of no greater than about 440 nm, such as from about 50 μm to 440 nm.

14. The composite layer according to claim 10, wherein the photocatalytic nanoparticles are present in an amount of from about 2 to about 40 vol. % of the composite layer.

15. The composite layer according to claim 10, wherein the layer is deposited on a substrate.

16. The composite layer according to claim 15, wherein the substrate is composed of a material selected from the list consisting of glass, ceramics, plastic, cross-linked elastomer, and mixtures thereof.

17. The composite layer according to claim 15, wherein the substrate is a peelable backing layer.

18. An article coated with a composite layer according to claim 10.

19. The article according to claim 18, wherein the article is a medical device, such as a medical tube (for example a catheter, or an endotracheal tube), a microneedle device, a wound dressing, or a high-touch object, such as a light emitting display panel, or a hand rail.

20. (canceled)

21. A method of treating and/or preventing a bacterial infection via the use of a composite layer as defined in claim 10.
